(19) United States
(12) Patent Application Publication
(10) Pub. No.: US 2017/0139479 A1
(43) Pub. Date: May 18, 2017

(54) TACTILE SENSATION CONTROL SYSTEM AND TACTILE SENSATION CONTROL METHOD

(71) Applicant: Mitsubishi Electric Corporation, Tokyo (JP)

(72) Inventors: Mitsuo SHIMOTANI, Tokyo (JP); Hidekazu ARITA, Tokyo (JP)

(73) Assignee: Mitsubishi Electric Corporation, Tokyo (JP)

(21) Appl. No.: 15/319,511

(22) PCT Filed: Sep. 9, 2014
(86) PCT No.: PCT/JP2014/073768

§ 371 Date: Dec. 16, 2016

(51) Int. Cl. G06F 3/01; G06F 3/0481; G06F 3/0488

(52) U.S. Cl. CPC G06F 3/016; G06F 3/04883; G06F 3/04817; G06F 2203/04803

(57) ABSTRACT

It is an object of the invention to provide a tactile sensation control system and a tactile sensation control method. The system includes: a processor to execute a program; and a memory to store the program which, when executed by the processor, performs processes of: acquiring operation area information on at least one operation area for operation by the user on the operation surface and on an operation type corresponding to the operation area, and controlling the tactile sensation on the operation surface so that the operation area in the acquired operation area information causes the user to have a tactile sensation according to the operation type corresponding to the operation area. The operation area includes a gesture operation area receiving a gesture operation by the user, and an icon operation area receiving an icon operation by the user.

### TECHNICAL FIELD

The present invention relates to a tactile sensation control system and a tactile sensation control method for control of a tactile sensation of a user operating an operation surface of a touch panel or a touch pad.

### BACKGROUND ART

There is a conventional technique of providing a tactile sensation according to operation to a user operating a display screen of a display device including a touch panel.

For example, there is disclosed a technique of irradiating a finger with ultrasonic waves to provide a finger with a tactile sensation (see, for example, Patent Documents 1 and 2). Another disclosed technique relates to vibrating an appropriate area on a touch panel by means of ultrasonic waves to provide a user with a tactile sensation (see, for example, Non-Patent Document 1). Still another disclosed technique relates to dynamically (physically) raising an appropriate area on a touch panel to provide a tactile sensation (see, for example, Patent Document 3).

### PRIOR ART DOCUMENTS

### Patent Documents

Patent Document 1: Japanese Patent Application Laid-Open No. 2003-29898

Patent Document 2: WO 2012/102026 A

Patent Document 3: Japanese Unexamined Patent Application Publication (Translation of PCT Application) No. 2005-512241

### Non-Patent Document

Non-Patent Document 1: “Trial production of tablet device equipped with touch panel providing tactile sensation”, (online), Feb. 24, 2014, FUJITSU LIMITED, (May 12, 2014), Internet <URL: http://pr.fujitsu.com/jp/news/2014/02/24.html?nw=pr>

### SUMMARY OF INVENTION

### Problem to be Solved by the Invention

Any one of the techniques according to Patent Documents 1 to 3 and Non-Patent Document 1 will allow a user to operate a device depending on tactile sensations with no visual concentration on a display screen. Unfortunately, Patent Documents 1 to 3 and Non-Patent Document 1 fail to disclose specific use and to provide a convenient user interface.

The present invention has been achieved in view of this defect, and an object thereof is to provide a tactile sensation control system and a tactile sensation control method, which allow a user to perform convenient operation with no visual concentration on a display screen.

### Means for Solving the Problem

In order to achieve the object mentioned above, the present invention provides a tactile sensation control system configured to control a tactile sensation of a user operating an operation surface of a touch panel or a touch pad. The system includes: an operation area information acquiring unit configured to acquire operation area information on at least one operation area for operation by the user on the operation surface and on an operation type corresponding to the operation area; and a tactile sensation controller configured to control the tactile sensation on the operation surface so that the operation area in the operation area information acquired by the operation area information acquiring unit causes the user to have a tactile sensation according to the operation type corresponding to the operation area.

The present invention also provides a tactile sensation control method of controlling a tactile sensation of a user operating an operation surface of a touch panel or a touch pad. The method includes: acquiring operation area information on an operation area for operation by the user on the operation surface and on an operation type corresponding to the operation area; and controlling the tactile sensation on the operation surface so that the operation area in the acquired operation area information causes the user to have a tactile sensation according to the operation type corresponding to the operation area.

### Effects of the Invention

The present invention provides a tactile sensation control system configured to control a tactile sensation of a user operating an operation surface of a touch panel or a touch pad. The system includes: an operation area information acquiring unit configured to acquire operation area information on at least one operation area for operation by the user on the operation surface and on an operation type corresponding to the operation area; and a tactile sensation controller configured to control the tactile sensation on the operation surface to cause the operation area in the operation area information acquired by the operation area information acquiring unit to have a tactile sensation according to the operation type corresponding to the operation area. The tactile sensation control system thus allows the user to operate comfortably with no visual concentration on a display screen.

The present invention also provides a tactile sensation control method of controlling a tactile sensation of a user operating an operation surface of a touch panel or a touch pad. The method includes: acquiring operation area information on an operation area for operation by the user on the operation surface and on an operation type corresponding to the operation area; and controlling the tactile sensation on the operation surface so that the operation area in the acquired operation area information causes the user to have a tactile sensation according to the operation type corresponding to the operation area. The tactile sensation control method thus allows the user to operate comfortably with no visual concentration on the display screen.

The object, features, aspects, and advantages of the present invention will become more apparent with the following detailed description and the accompanying drawings.

### BRIEF DESCRIPTION OF DRAWINGS

FIG. 1 is a block diagram depicting an exemplary configuration of a tactile sensation control apparatus according to an embodiment 1 of the present invention.

FIG. 2 is an explanatory diagram on tactile sensations according to the embodiment 1 of the present invention.

FIG. 3 is an explanatory graph on tactile sensations according to the embodiment 1 of the present invention.

FIG. 4 is an explanatory graph on tactile sensations according to the embodiment 1 of the present invention.

FIG. 5 is an explanatory graph on tactile sensations according to the embodiment 1 of the present invention.

FIG. 6 is an explanatory diagram on a tactile sensation according to the embodiment 1 of the present invention.

FIG. 7 is a block diagram depicting another exemplary configuration of the tactile sensation control apparatus according to the embodiment 1 of the present invention.

FIG. 8 is a flowchart of exemplary behaviors of the tactile sensation control apparatus according to the embodiment 1 of the present invention.

FIG. 9 is a diagram depicting an exemplary behavior of the tactile sensation control apparatus according to the embodiment 1 of the present invention.

FIG. 10 is a diagram indicating an exemplary behavior of the tactile sensation control apparatus according to the embodiment 1 of the present invention.

FIG. 11 is a diagram indicating an exemplary behavior of the tactile sensation control apparatus according to the embodiment 1 of the present invention.

FIG. 12 is a block diagram depicting an exemplary configuration of a tactile sensation control apparatus according to an embodiment 2 of the present invention.

FIG. 13 is a flowchart of exemplary behaviors of the tactile sensation control apparatus according to the embodiment 2 of the present invention.

FIG. 14 is a diagram depicting an exemplary behavior of the tactile sensation control apparatus according to the embodiment 2 of the present invention.

FIG. 15 is a diagram depicting an exemplary behavior of the tactile sensation control apparatus according to the embodiment 2 of the present invention.

FIG. 16 is a diagram depicting an exemplary behavior of a tactile sensation control apparatus according to an embodiment 3 of the present invention.

FIG. 17 is a flowchart of exemplary behaviors of a tactile sensation control apparatus according to an embodiment 4 of the present invention.

FIG. 18 is a diagram depicting an exemplary behavior of the tactile sensation control apparatus according to the embodiment 4 of the present invention.

FIG. 19 is a diagram depicting an exemplary behavior of the tactile sensation control apparatus according to the embodiment 4 of the present invention.

FIG. 20 is a diagram depicting an exemplary behavior of the tactile sensation control apparatus according to the embodiment 4 of the present invention.

FIG. 21 is a diagram depicting an exemplary behavior of the tactile sensation control apparatus according to the embodiment 4 of the present invention.

FIG. 22 is a diagram depicting an exemplary behavior of the tactile sensation control apparatus according to the embodiment 4 of the present invention.

FIG. 23 is a diagram depicting an exemplary behavior of the tactile sensation control apparatus according to the embodiment 4 of the present invention.

FIG. 24 is a diagram depicting an exemplary behavior of a tactile sensation control apparatus according to an embodiment 5 of the present invention.

FIG. 25 is a diagram depicting an exemplary behavior of the tactile sensation control apparatus according to the embodiment 5 of the present invention.

FIG. 26 is a block diagram depicting an exemplary configuration of a tactile sensation control apparatus according to an embodiment 6 of the present invention.

FIG. 27 is a flowchart of exemplary behaviors of the tactile sensation control apparatus according to the embodiment 6 of the present invention.

FIG. 28 is a diagram depicting an exemplary behavior of the tactile sensation control apparatus according to the embodiment 6 of the present invention.

FIG. 29 is a diagram depicting an exemplary behavior of the tactile sensation control apparatus according to the embodiment 6 of the present invention.

FIG. 30 is a diagram depicting an exemplary behavior of the tactile sensation control apparatus according to the embodiment 6 of the present invention.

FIG. 31 is a diagram depicting an exemplary behavior of the tactile sensation control apparatus according to the embodiment 6 of the present invention.

FIG. 32 is a block diagram depicting an exemplary configuration of a tactile sensation control system according to an embodiment of the present invention.

FIG. 33 is a block diagram depicting another exemplary configuration of the tactile sensation control system according to the embodiment of the present invention.

### DESCRIPTION OF EMBODIMENTS

Embodiments of the present invention will now be described below with reference to the drawings.

### Embodiment 1

Initially described will be a configuration of a tactile sensation control system according to the embodiment 1 of the present invention. The present embodiment and the embodiments to be described later will refer to a case where a tactile sensation control system is embodied only by a tactile sensation control apparatus.

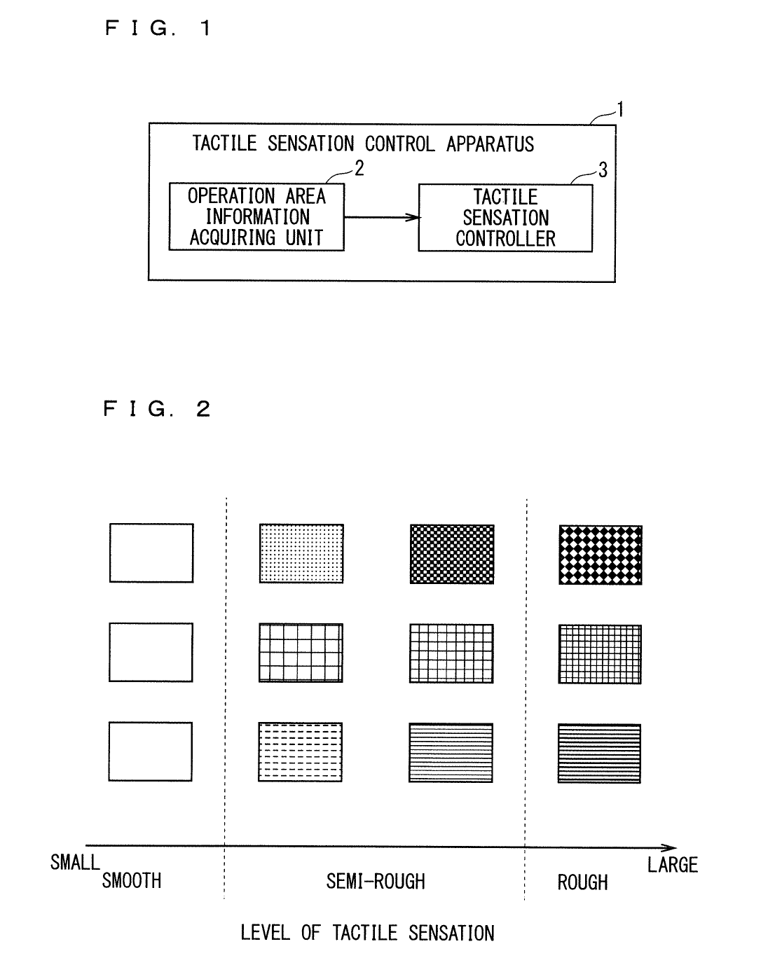

FIG. 1 is a block diagram depicting an exemplary configuration of a tactile sensation control apparatus 1 according to the present embodiment 1. FIG. 1 depicts minimum necessary constituent elements configuring the tactile sensation control apparatus 1.

As depicted in FIG. 1, the tactile sensation control apparatus 1 includes at least an operation area information acquiring unit 2 and a tactile sensation controller 3.

The operation area information acquiring unit 2 acquires operation area information or information on a user operation area on an operation surface of a touch panel or a touch pad and on an operation type corresponding to the operation area.

The tactile sensation controller 3 controls a tactile sensation on the operation surface so that the operation area in the operation area information acquired by the operation area information acquiring unit 2 causes the user to have a tactile sensation according to the operation type corresponding to the operation area.

Tactile sensations controlled by the tactile sensation controller 3 will be described below with reference to FIGS. 2 to 6.

FIG. 2 is a diagram depicting three exemplary types of tactile sensations, namely, “smooth”, “semi-rough”, and “rough” tactile sensations.

FIG. 2 has a transverse axis indicating tactile sensation levels. The leftmost column includes “smooth” tactile sensations, the two central columns include “semi-rough” tactile sensations, and the rightmost column includes “rough” tactile sensations. A tactile sensation in each of entire quadrangles is expressed by vibration of ultrasonic waves or the like, of dot or line patterns indicated in black in the quadrangles. In a case where vibration in quadrangles is equal in level, “rough” tactile sensations increase in level gradually from the left to the right in FIG. 2. Specifically, a larger dot indicates a rougher tactile sensation in the first line in FIG. 2, a narrower grid indicates a rougher tactile sensation in the second line, and a solid line rather than a broken line as well as a thicker line indicate a rougher tactile sensation in the third line. Such rough tactile sensation patterns are not limited to those indicated in FIG. 2 and there are an infinite number of combination patterns.

FIG. 2 exemplifies a technique of obtaining different rough tactile sensations with different patterns even at a single vibration level. It is also possible to obtain different rough tactile sensations with different vibration levels even in a single pattern.

A “smooth” tactile sensation is expressed by, for example, no ultrasonic vibration.

A “rough” tactile sensation is expressed by, for example, ultrasonic vibration of a level equal to or more than a predetermined threshold.

A “semi-rough” tactile sensation is expressed by, for example, ultrasonic vibration of a level less than the predetermined threshold.

Rough tactile sensations of different levels are expressed by combination between vibration levels and the rough tactile sensation patterns depicted in FIG. 2.

FIG. 2 illustrates the rough tactile sensation patterns and generation of a static rough tactile sensation without change in vibration level. A moving rough tactile sensation can also be expressed by temporal change in vibration level or by temporal change in rough tactile sensation pattern (i.e. by dynamic change in vibration level or in rough tactile sensation pattern).

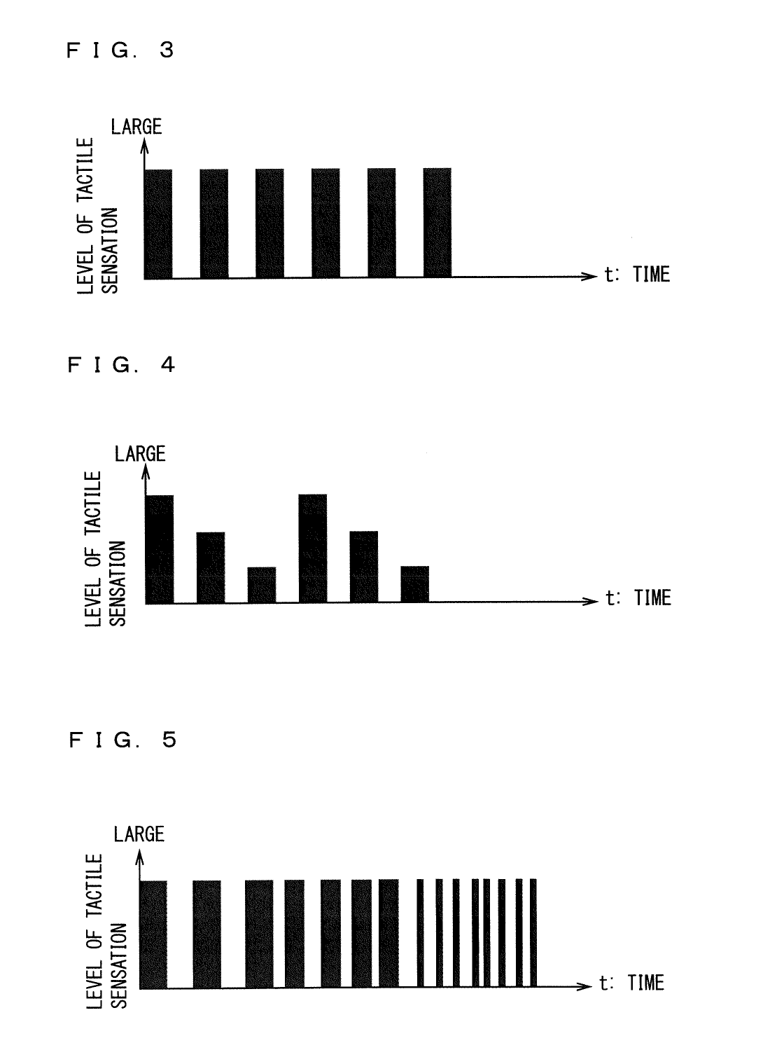

FIGS. 3 to 5 are exemplary graphs of generation of a “moving rough” tactile sensation by temporal change in vibration level. FIGS. 3 to 5 each have a transverse axis indicating time and an ordinate axis indicating tactile sensation levels.

FIG. 3 indicates a case of generating tactile sensations at a constant level at regular intervals. FIG. 4 indicates a case of generating tactile sensations at changed levels at regular intervals. FIG. 5 indicates a case of generating tactile sensations at a constant level at irregular intervals.

Tactile sensation change indicated in FIGS. 3 to 5 allows a user to obtain a tactile sensation as if a “rough” area moves (i.e. a “moving rough” tactile sensation). FIGS. 3 to 5 exemplify alternately switching between “rough” tactile sensations and “smooth” tactile sensations. In addition, “rough” tactile sensations and “semi-rough” tactile sensations are switched alternately, “rough” tactile sensations are switched not discretely but continuously, or continuous change and discrete change are combined freely.

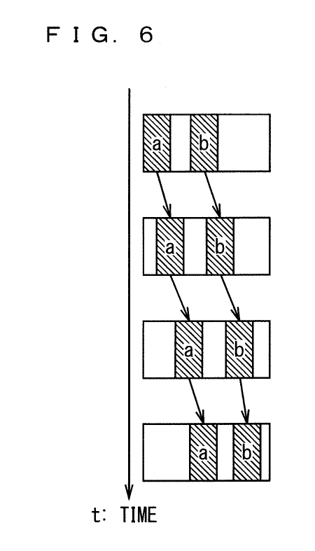

FIG. 6 is a diagram depicting another exemplary case of generating a “moving rough” tactile sensation by temporal change in rough tactile sensation pattern. FIG. 6 has an ordinate axis indicating time. FIG. 6 also depicts areas a and b each having a “rough” tactile sensation, for example.

As depicted in FIG. 6, the areas a and b are positionally changed with a lapse of time. Such movement of the areas a and b having tactile sensations allows a user to obtain a tactile sensation as if a “rough” area moves (i.e. a “moving rough” tactile sensation). Each of the areas a and b can have tactile sensations indicated in any one of FIGS. 3 to 5.

FIG. 6 exemplifies temporal movement of an area having a “rough” tactile sensation and an area having a “smooth” tactile sensation. Alternatively, an area having a “rough” tactile sensation and an area having a “semi-rough” tactile sensation are provided and moved temporally, or an area having a “rough” tactile sensation changed discretely or continuously is provided and moved temporally. Adoption of a “rough” tactile sensation changed continuously in FIGS. 3 to 6 leads to a seamless “moving rough” tactile sensation.

Described next is another configuration of the tactile sensation control apparatus 1 including the operation area information acquiring unit 2 and the tactile sensation controller 3 depicted in FIG. 1.

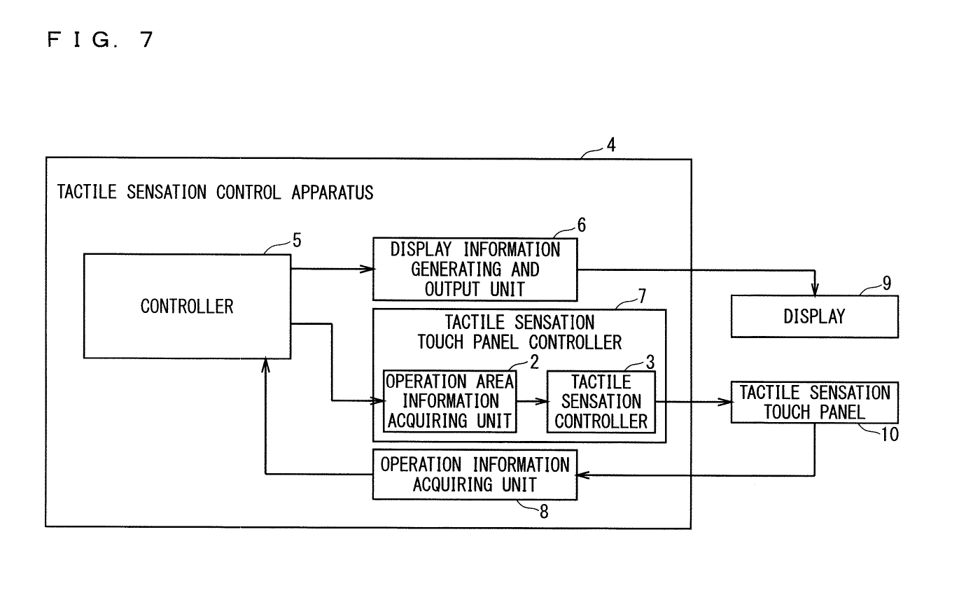

FIG. 7 is a block diagram depicting an exemplary configuration of a tactile sensation control apparatus 4.

As depicted in FIG. 7, the tactile sensation control apparatus 4 includes a controller 5, a display information generating and output unit 6, a tactile sensation touch panel controller 7, and an operation information acquiring unit 8. The display information generating and output unit 6 is connected to a display 9, and the tactile sensation touch panel controller 7 and the operation information acquiring unit 8 are connected to a tactile sensation touch panel 10.

The controller 5 controls the entire tactile sensation control apparatus 4. FIG. 7 exemplifies a case where the controller 5 controls the display information generating and output unit 6 and the tactile sensation touch panel controller 7.

The display information generating and output unit 6 generates display information in accordance with a command from the controller 5. The display information generating and output unit 6 also converts the generated display information to an image signal and transmits the image signal to the display 9.

The tactile sensation touch panel controller 7 includes the operation area information acquiring unit 2 and the tactile sensation controller 3. The operation area information acquiring unit 2 acquires operation area information transmitted from the controller 5. The tactile sensation controller 3 transmits, to the tactile sensation touch panel 10, tactile sensation control information on control of a tactile sensation on the operation surface to cause the operation area in the operation area information acquired by the operation area information acquiring unit 2 to have a tactile sensation according to the operation type corresponding to the operation area.

The operation information acquiring unit 8 acquires, from the tactile sensation touch panel 10, operation information or information on a user operation to the tactile sensation touch panel 10 and on an operation type corresponding to the operation area.

The display 9 displays, on a display screen, the display information transmitted from the display information generating and output unit 6.

The tactile sensation touch panel 10 transmits, to the operation information acquiring unit 8, operation information or information on user touch operation (information on whether or not touched, a touched position, operation details, and the like). The tactile sensation touch panel 10 has tactile sensation change at an appropriate position on the touch panel (“smooth”, “semi-rough”, “rough”, or “moving rough”) according to the tactile sensation control information transmitted from the tactile sensation touch panel controller 7.

The tactile sensation touch panel 10 is provided on the display screen of the display 9, so that a user operates the tactile sensation touch panel 10 with a sensation of direct operation to the display screen. In other words, an area of the display screen of the display 9 can completely agree to an area generating tactile sensations on the tactile sensation touch panel 10. Alternatively, either one of the area of the display screen of the display 9 and the area generating tactile sensations on the tactile sensation touch panel 10 can be larger than the other one. For example, the tactile sensation touch panel 10 is disposed such that the area generating tactile sensations on the tactile sensation touch panel 10 protrudes from the area of the display screen of the display 9, and the protruding area is configured not to display but to receive touch operation.

Behaviors of the tactile sensation control apparatus 4 will be described next.

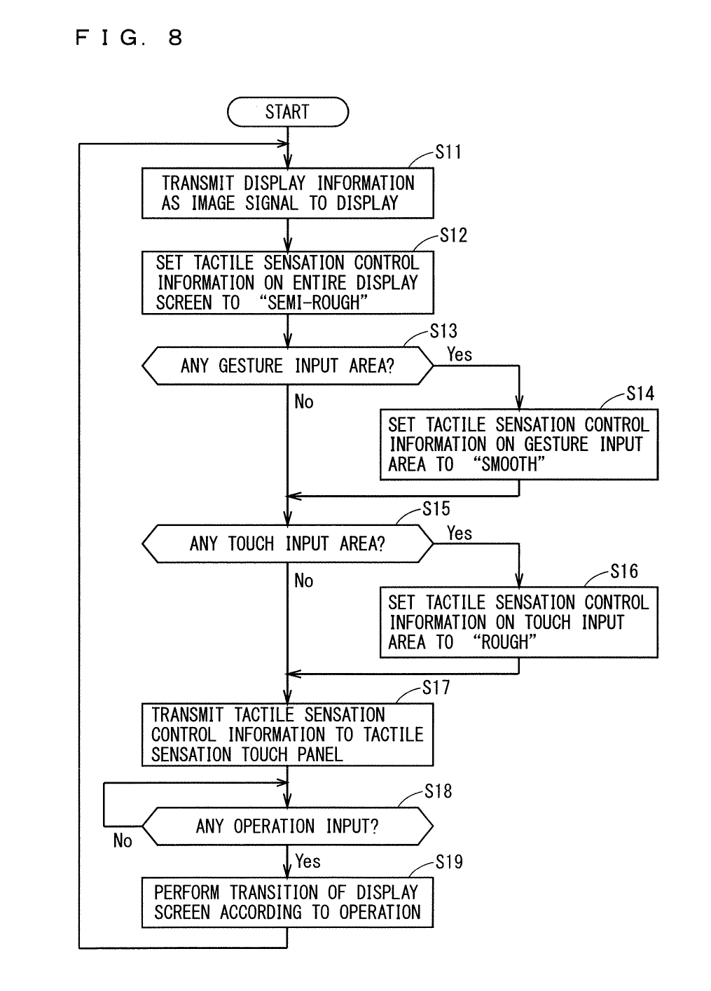

FIG. 8 is a flowchart of exemplary behaviors of the tactile sensation control apparatus 4.

In step S11, the display information generating and output unit 6 generates display information in accordance with a command from the controller 5, converts the generated display information to an image signal, and transmits the image signal to the display 9.

In step S12, the tactile sensation touch panel controller 7 sets tactile sensation control information on the entire display screen (i.e. the entire tactile sensation touch panel 10) to “semi-rough” in accordance with the command from the controller 5.

In step S13, the controller 5 determines whether or not the display screen of the display 9 displayed in accordance with the image signal converted in step Sll includes a gesture input area. If there is the gesture input area, the process proceeds to step S14. If there is no gesture input area, the process proceeds to step S15. The gesture input area on the display screen allows a user to input through gesture operation.

In step S14, the tactile sensation touch panel controller 7 sets tactile sensation control information on the gesture input area to “smooth” in accordance with the command from the controller 5.

In step S15, the controller 5 determines whether or not the display screen of the display 9 displayed in accordance with the image signal converted in step Sll includes a touch input area. If there is the touch input area, the process proceeds to step S16. If there is no touch input area, the process proceeds to step S17. The touch input area on the display screen allows a user to input through touch operation.

In step S16, the tactile sensation touch panel controller 7 sets tactile sensation control information on the touch input area to “rough” in accordance with the command from the controller 5.

In step S17, the tactile sensation touch panel controller 7 transmits, to the tactile sensation touch panel 10, the tactile sensation control information set in steps S12, S14, and S16. The tactile sensation touch panel 10 comes into a state where areas have different tactile sensations according to the tactile sensation control information transmitted from the tactile sensation touch panel controller 7.

In step S18, the controller 5 determines whether or not a user operates the tactile sensation touch panel 10 via the operation information acquiring unit 8. The controller 5 stands by until a user operates the tactile sensation touch panel 10, and the process proceeds to step S19 if the user operates the tactile sensation touch panel 10.

In step S19, the controller 5 performs transition of the display screen according to user operation.

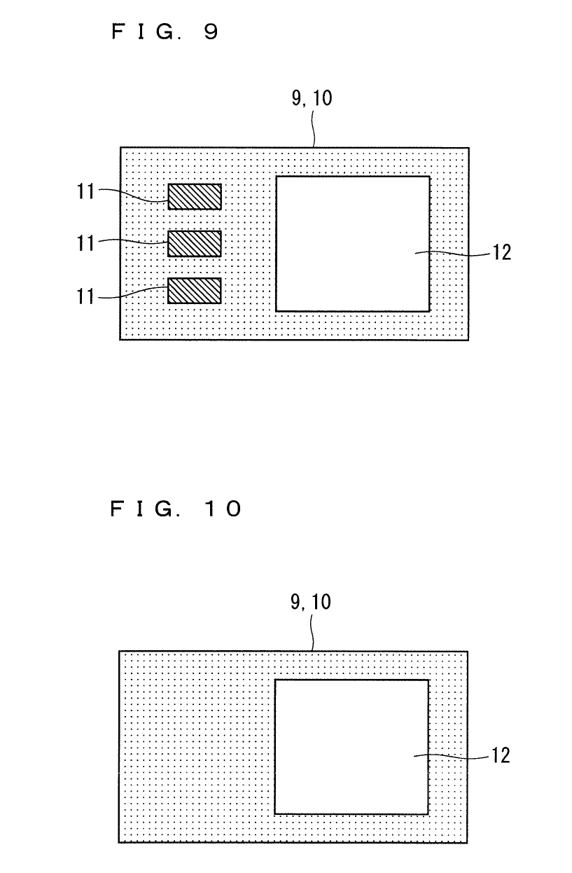

Exemplary specific behaviors of the tactile sensation control apparatus 4 will be described next with reference to FIGS. 9 to 11.

The display screen of the display 9 in FIG. 9 includes operation icons 11 configured to receive operation to the icon (icon operation) through touch input, and a gesture area 12 configured to receive gesture operation. On the tactile sensation touch panel 10, areas of the operation icons 11 have a “rough” tactile sensation, the gesture area 12 has a “smooth” tactile sensation, and the area other than the operation icons 11 and the gesture area 12 (non-operation area) has a “semi-rough” tactile sensation. Such differentiation in tactile sensation among the areas allows a user to easily distinguish an operable type (icon operation or gesture operation). Touch input according to the present embodiment 1 is assumed to include an operation manner of allowing a user to have a tactile sensation of preliminary icon operation if the user lightly touches the operation surface of the tactile sensation touch panel 10 and receiving icon operation if the user strongly presses the operation surface.

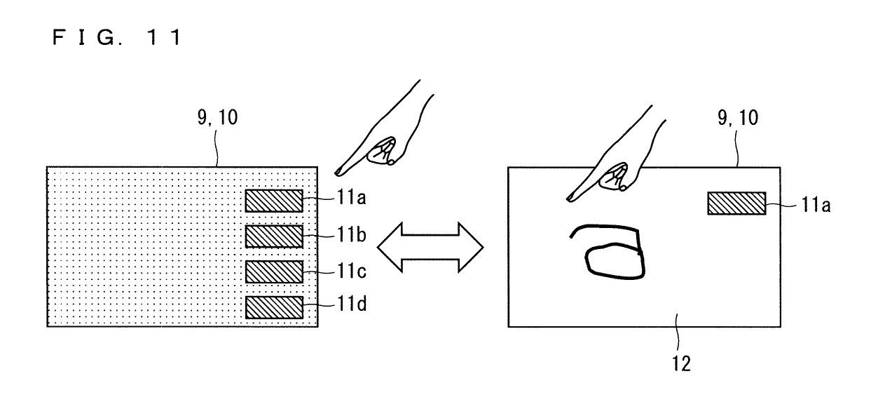

The display screen of the display 9 includes the gesture area 12 in FIG. 10. On the tactile sensation touch panel 10, the gesture area 12 has a “smooth” tactile sensation and the area other than the gesture area 12 has a “semi-rough” tactile sensation. Such differentiation in tactile sensation between the gesture area 12 and the remaining area (non-operation area) allows a user to easily distinguish the gesture area 12.

FIG. 11 depicts transition of the display screen.

In the left portion in FIG. 11, the display screen of the display 9 includes operation icons 11a to 11d for transition into a handwriting input mode. On the tactile sensation touch panel 10, areas of the operation icons 11 have a “rough” tactile sensation while the area other than the operation icons 11a to 11d has a “semi-rough” tactile sensation. When a user touches the operation icon 11a in the left portion in FIG. 11, the display screen transitions to the state depicted in the right portion in FIG. 11.

In the right portion in FIG. 11, the display screen of the display 9 includes the operation icon 11a for cancellation of the handwriting input mode, and the gesture area 12 allowing handwriting input. On the tactile sensation touch panel 10, the area of the operation icon 11a has a “rough” tactile sensation while the gesture area 12 has a “smooth” tactile sensation. When a user touches the operation icon 11a in the right portion in FIG. 11, the display screen transitions to the state depicted in the left portion in FIG. 11.

The operation icon 11a depicted in FIGS. 9 and 11 can alternatively have a “moving rough” tactile sensation, or can have a physically rising shape formed in accordance with the manner disclosed in Patent Document 3.

As described above, the areas have the different tactile sensations according to the operation types (icon operation and gesture operation) in the present embodiment 1, so that a user does not need to visually focus on the display screen during operation. This enables convenient operation for the user.

The embodiment 1 exemplifies a case where the tactile sensation control apparatus 4 is mounted on a vehicle. The functions described in the embodiment 1 are achievable also on a smartphone. The smartphone, which may be operated by a walking user, effectively prevents deterioration in attention to the surrounding situation.

### Embodiment 2

Initially described will be a configuration of a tactile sensation control apparatus according to the present embodiment 2 of the present invention.

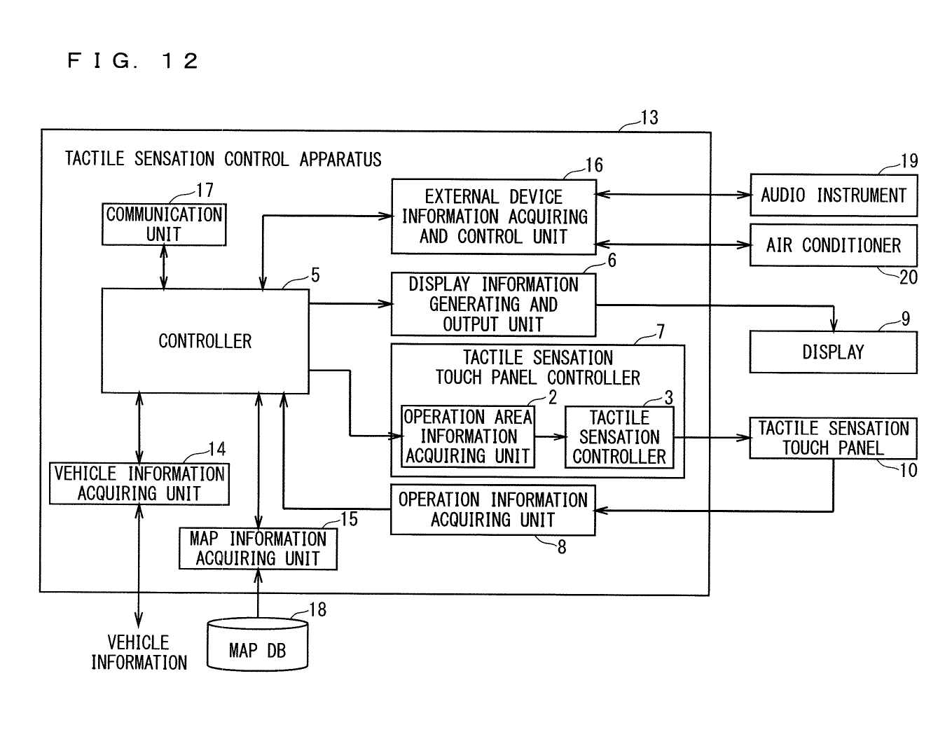

FIG. 12 is a block diagram depicting an exemplary configuration of a tactile sensation control apparatus 13 according to the present embodiment 2.

As depicted in FIG. 12, the tactile sensation control apparatus 13 includes a vehicle information acquiring unit 14, a map information acquiring unit 15, an external device information acquiring and control unit 16, and a communication unit 17. The external device information acquiring and control unit 16 is connected with an audio instrument 19 and an air conditioner 20, while the map information acquiring unit 15 is connected with a map database (DB) 18. The other configurations are similar to those according to the embodiment 1 (see FIG. 7) and will not herein be described repeatedly.

The vehicle information acquiring unit 14 acquires, via an in-vehicle local area network (LAN), vehicle information such as sensor information detected by various sensors provided in the vehicle (e.g. vehicle speed pulse information), vehicle control information, or global positioning system (GPS) information.

The map information acquiring unit 15 acquires map information from the map DB 18.

The external device information acquiring and control unit 16 acquires external device information (operation target device information) or information on external devices (the audio instrument 19 and the air conditioner 20) to be operated by a user. In other words, the external device information acquiring and control unit 16 functions as an operation target device information acquiring unit. The external device information acquiring and control unit 16 also controls the external devices (the audio instrument 19 and the air conditioner 20).

The communication unit 17 is communicably connected with a communication terminal (not depicted).

The map DB 18 stores map information. The map DB 18 can be mounted on the vehicle or be provided externally.

Behaviors of the tactile sensation control apparatus 13 will be described next.

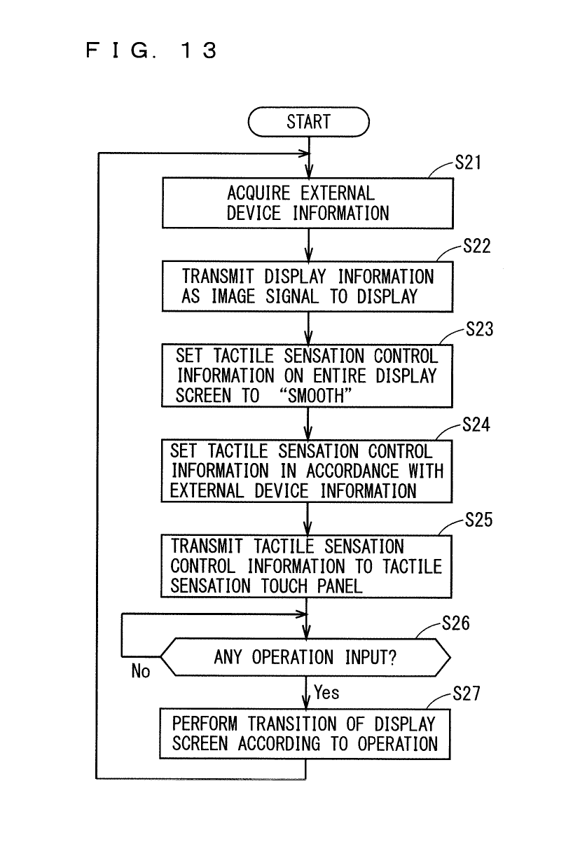

FIG. 13 is a flowchart of exemplary behaviors of the tactile sensation control apparatus 13. Steps S25 to S27 in FIG. 13 correspond to steps S17 to S19 in FIG. 8, and will not herein be described repeatedly.

In step S21, the external device information acquiring and control unit 16 acquires external device information from the external devices (the audio instrument 19 or the air conditioner 20). The acquired external device information is transmitted to the controller 5.

In step S22, the display information generating and output unit 6 generates display information in accordance with a command from the controller 5, converts the generated display information to an image signal, and transmits the image signal to the display 9. The display information includes the external device information in this case.

In step S23, the tactile sensation touch panel controller 7 sets tactile sensation control information on the entire display screen to “smooth” in accordance with the command from the controller 5.

In step S24, the tactile sensation touch panel controller 7 sets different tactile sensation control information on each of the areas of the icons for operation of the external devices in accordance with the command from the controller 5.

Exemplary specific behaviors of the tactile sensation control apparatus 13 will be described next with reference to FIG. 14.

The display screen of the display 9 in FIG. 14 includes navigation operation icons 21, air conditioner operation icons 22, and a hands-free operation icon 23. On the tactile sensation touch panel 10, areas of the navigation operation icons 21 have a “rough” tactile sensation, areas of the air conditioner operation icons 22 have a “moving rough” tactile sensation, and an area of the hands-free operation icon 23 has a “semi-rough” tactile sensation.

A user touches the navigation operation icon 21 to perform operation relevant to navigation (e.g. operation for route search from the current position to a destination). In a case where the user touches the navigation operation icon 21, the controller 5 performs processing relevant to navigation such as route search in accordance with the vehicle information acquired by the vehicle information acquiring unit 14 and the map information acquired by the map information acquiring unit 15.

A user touches the air conditioner operation icon 22 to perform operation relevant to the air conditioner 20 (e.g. temperature adjusting operation). In a case where the user touches the air conditioner operation icon 22, the controller 5 issues a command to the external device information acquiring and control unit 16 to control the air conditioner 20. The external device information acquiring and control unit 16 controls the air conditioner 20 in accordance with the command from the controller 5.

A user touches the hands-free operation icon 23 to achieve a hands-free call. In a case where the user touches the hands-free operation icon 23, the controller 5 establishes communication between the communicator 17 and the communication terminal and controls the communication so that the user can perform a hands-free call via the communication terminal.

The navigation operation icons 21, the air conditioner operation icons 22, and the hands-free operation icon 23 depicted in FIG. 14 can each have a physically rising shape. Still alternatively, the area other than the navigation operation icons 21, the air conditioner operation icons 22, and the hands-free operation icon 23 can have a “smooth” tactile sensation.

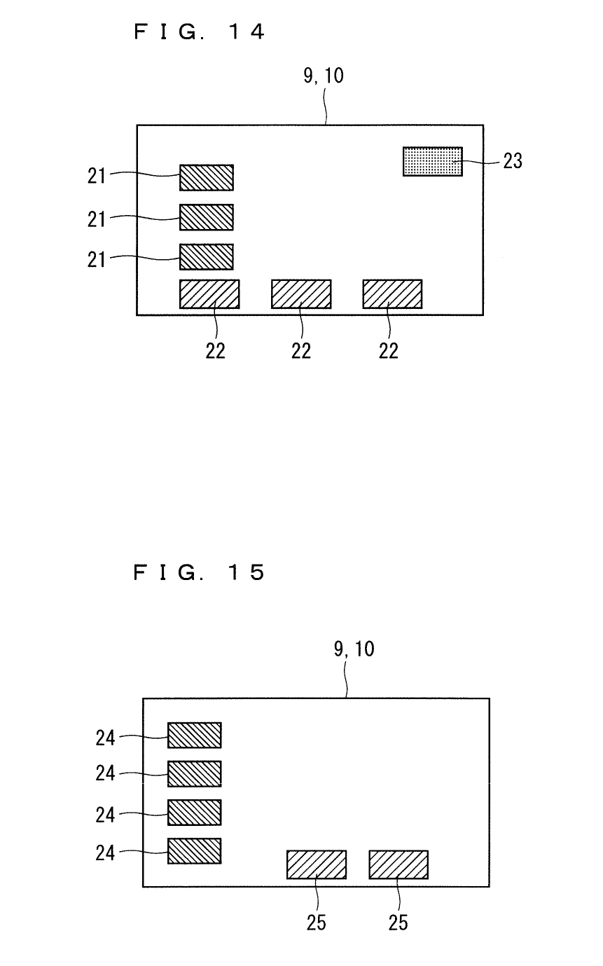

The above example refers to the case where the icon areas for the different external devices have different tactile sensations, but does not intend to limit the present invention. For example, the icon areas can have different tactile sensations for respective similar functions of a specific external device (i.e. an identical external device). FIG. 15 depicts an exemplary case where the icon areas have different tactile sensations for respective functions of a specific external device.

The display screen of the display 9 in FIG. 15 includes map scale switching icons 24 and display switching icons 25. Examples of the display switching icons 25 include an icon for switching display of north-up or heading-up. On the tactile sensation touch panel 10, areas of the map scale switching icons 24 have a “rough” tactile sensation while areas of the display switching icons 25 have a “moving rough” tactile sensation.

FIG. 15 exemplarily depicts a navigation screen, which does not intend to limit the present invention. In an exemplary case where FIG. 15 depicts an audio screen, a volume control icon area and a channel switching icon area can have different tactile sensations. The map scale switching icons 24 and the display switching icons 25 depicted in FIG. 15 can each have a physically rising shape.

As described above, the icon areas have the different tactile sensations for the respective external devices or the respective functions of the external devices in the present embodiment 2, so as to allow a user to select an intended icon. This enables convenient operation for the user.

### Embodiment 3

The embodiment 3 of the present invention will refer to a case where the display 9 displays two screens. A tactile sensation control apparatus according to the present embodiment 3 is configured similarly to the tactile sensation control apparatus 13 according to the embodiment 2 (see FIG. 12) and will not herein be described repeatedly.

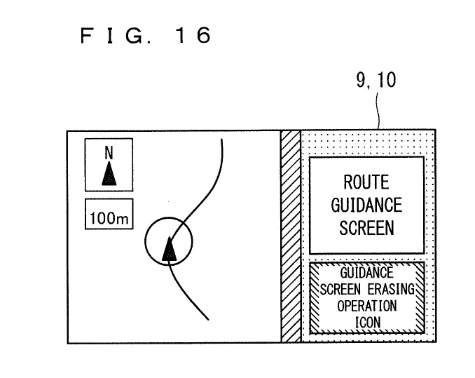

FIG. 16 is a diagram depicting an exemplary behavior of the tactile sensation control apparatus according to the present embodiment 3.

The display 9 depicted in FIG. 16 displays a left screen including a map indicating a position of the vehicle and a right screen including a route guidance screen and a guidance screen erasing operation icon. On the tactile sensation touch panel 10, a boundary area between the two screens has a “moving rough” tactile sensation, and an area of the left screen has a “smooth” tactile sensation. On the right screen, an area of the route guidance screen has a “smooth” tactile sensation, an area of the guidance screen erasing operation icon has a “rough” tactile sensation, and the remaining area has a “semi-rough” tactile sensation.

FIG. 16 exemplifies the case where the boundary area between the two screens has the different tactile sensation. Alternatively, background areas of the two screens can have a different tactile sensation.

As described above, the present embodiment 3 allows a user to recognize the areas of the two screens through the tactile sensations to prevent the user from operating a wrong screen. This enables convenient operation for the user.

Application of the present embodiment 3 to display of multiple screens of three or more screens will achieve effects similar to those of the present embodiment 3.

### Embodiment 4

The embodiment 4 of the present invention will refer to a case where the display 9 displays a keyboard. A tactile sensation control apparatus according to the present embodiment 4 is configured similarly to the tactile sensation control apparatus 4 according to the embodiment 1 (see FIG. 7) or the tactile sensation control apparatus 13 according to the embodiment 2 (see FIG. 12), and will not herein be described repeatedly.

FIG. 17 is a flowchart of exemplary behaviors of the tactile sensation control apparatus according to the present embodiment 4. Steps S35 to S37 in FIG. 17 correspond to steps S17 to S19 in FIG. 8, and will not herein be described repeatedly.

In step S31, the controller 5 acquires keyboard information. The keyboard information can alternatively be kept by the controller 5 or be stored in another storage (not depicted).

In step S32, the display information generating and output unit 6 generates display information in accordance with a command from the controller 5, converts the generated display information to an image signal, and transmits the image signal to the display 9. The display information includes the keyboard information in this case.

In step S33, the tactile sensation touch panel controller 7 sets tactile sensation control information on the entire display screen to a predetermined tactile sensation in accordance with the command from the controller 5.

In step S34, the tactile sensation touch panel controller 7 sets tactile sensation control information on each key area in accordance with the command from the controller 5.

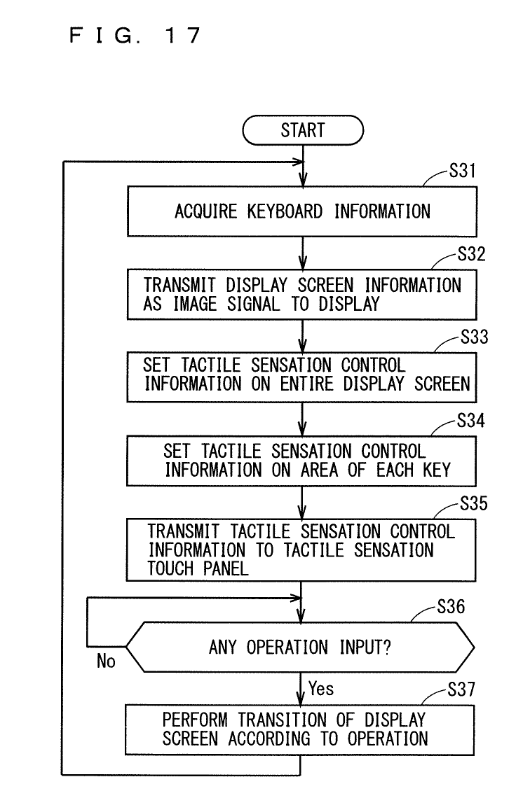

Exemplary specific behaviors of the tactile sensation control apparatus according to the present embodiment 4 will be described next with reference to FIGS. 18 to 23.

The display screen of the display 9 includes a keyboard in FIG. 18. On the tactile sensation touch panel 10, key areas have a “smooth” tactile sensation while a background area other than the key areas has a “moving rough” tactile sensation. Such differentiation in tactile sensation between the key areas and the remaining area allows a user to easily recognize boundaries between the adjacent keys to easily distinguish positions of the keys. This prevents erroneous operation of simultaneously touching two or more keys.

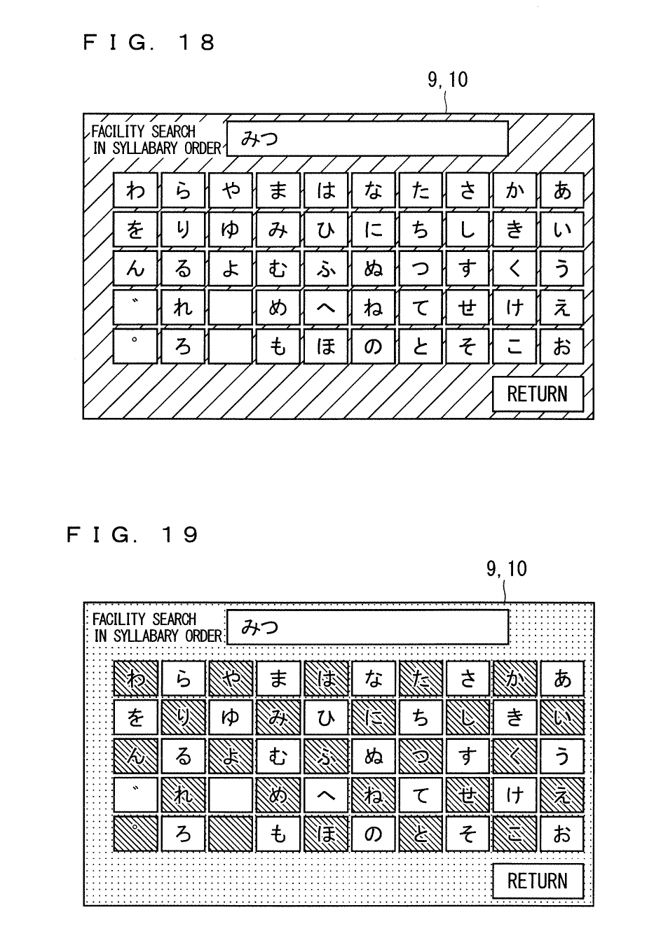

The display screen of the display 9 includes a keyboard in FIG. 19. On the tactile sensation touch panel 10, the key areas each have a “smooth” tactile sensation or a “rough” tactile sensation and are arrayed to have these tactile sensations alternately both in the row and column directions. In other words, the tactile sensations of the keys (operation areas) are differentiated regularly. The background area other than the key areas has a “semi-rough” tactile sensation. Such differentiation in tactile sensation between the adjacent key areas allows a user to easily distinguish the positions of the keys. This prevents a user from performing erroneous operation of touching an adjacent wrong key. This is particularly effective for prevention of erroneous operation in a case where the display 9 and the tactile sensation touch panel 10 are not placed right in front of user's eyes but are placed diagonally in front thereof, namely, are shifted diagonally upward, downward, leftward, or rightward.

The display screen of the display 9 includes a keyboard in FIG. 20. On the tactile sensation touch panel 10, the key areas each have a “smooth” tactile sensation or a “rough” tactile sensation and are arrayed to have these tactile sensations alternately in the column direction. In other words, the tactile sensations of the keys (operation areas) are differentiated regularly. The background area other than the key areas has a “semi-rough” tactile sensation. Such differentiation in tactile sensation between adjacent key areas in the column direction allows a user operating the keys placed aside to recognize vision disparity to easily distinguish the positions of the keys.

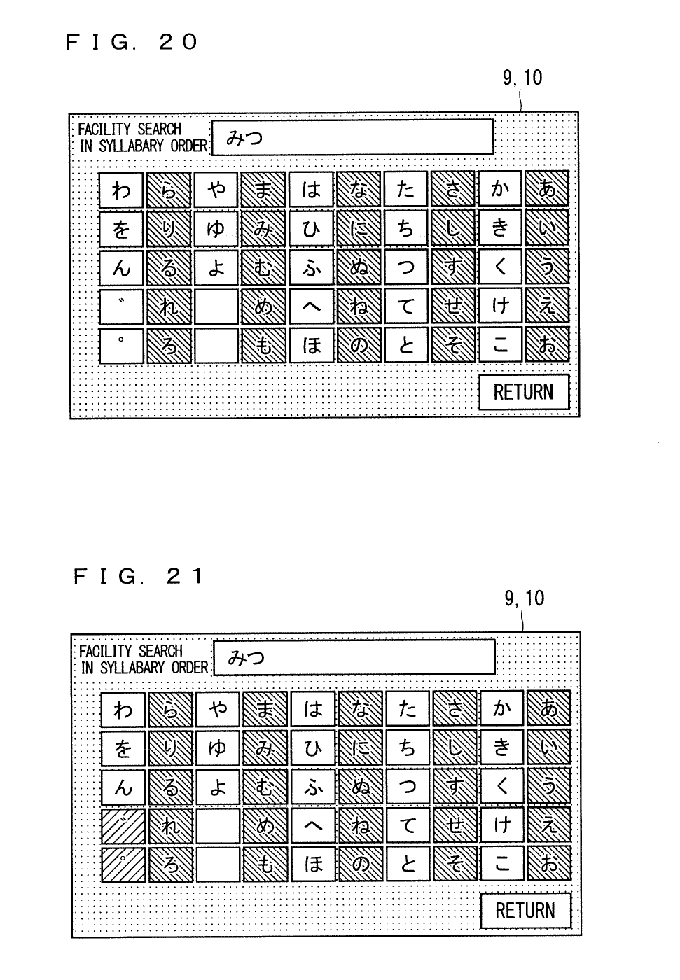

In FIG. 21, areas of auxiliary operation icons (predetermined operation areas) are differentiated in tactile sensation from the key areas. The remaining areas have similar tactile sensations to those in FIG. 20. Such differentiation in tactile sensation between the key areas and the areas of the auxiliary operation icons allows a user to easily distinguish positions of the auxiliary operation icons.

In exemplary Japanese input in FIG. 21, the auxiliary operation icons correspond to a voiced sound icon “″” and a semi-voiced sound icon “°”. Dual icon operation achieves input of a single letter when one of these auxiliary operation icons is used. Tactile sensations will similarly be differentiated in a case where input of a single letter in a foreign language through a software keyboard requires any “auxiliary operation icon”. Tactile sensations can alternatively be differentiated between letters of different types instead of differentiating the tactile sensations of the auxiliary operation icons. Examples of such letters of different types include “alphabets”, “numbers”, special characters like “#$& ”, and “umlaut” in German.

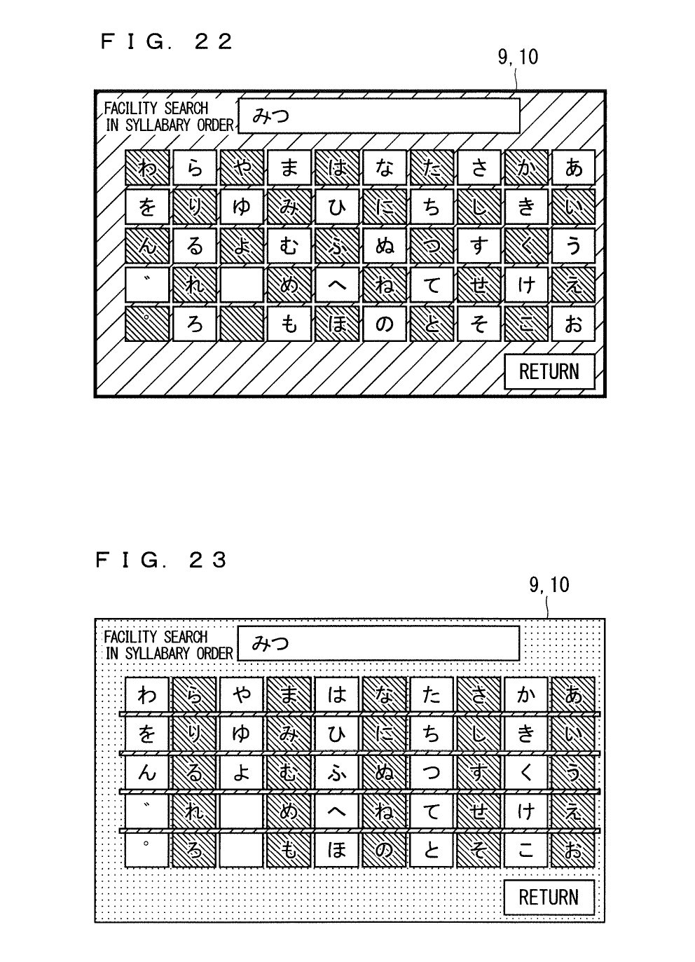

In FIG. 22, the area other than the key areas has a “moving rough” tactile sensation. The remaining areas have similar tactile sensations to those in FIG. 19. Such differentiation in tactile sensation between the key areas and the remaining area allows a user to easily distinguish the positions of the keys.

In FIG. 23, boundary areas between the keys aligned in the row direction are differentiated in tactile sensation from the key areas. The remaining areas have similar tactile sensations to those in FIG. 20. Such differentiation in tactile sensation of the boundary areas between the keys from the key areas allows a user to easily distinguish the positions of the keys. FIG. 23 exemplifies the differentiation in tactile sensation of the boundary areas in the row direction. The boundary areas in the column direction can alternatively be differentiated in tactile sensation.

FIGS. 18 to 23 exemplify the keyboard for facility search, but the present invention is not limited thereto. Tactile sensations can be differentiated between adjacent keys or operation icons with a narrow space therebetween. Operation icons having similar functions, such as operation icons for turning volume up and down or operation icons for scrolling in eight directions on a map, are typically positioned adjacently. The differentiation in tactile sensation reduces erroneous operation to these operation icons. An effect similar to the above is achieved also in a case where a smartphone displays a plurality of icons for starting up different applications.

As described above, the present embodiment 4 prevents user's erroneous keyboard operation. This enables convenient operation for the user.

### Embodiment 5

The embodiment 5 of the present invention will refer to a case where the tactile sensation touch panel 10 extends to reach an area (non-display area) outside the display screen (display area) of the display 9. A tactile sensation control apparatus according to the present embodiment 5 is configured similarly to the tactile sensation control apparatus 13 according to the embodiment 2 (see FIG. 12) and will not herein be described repeatedly.

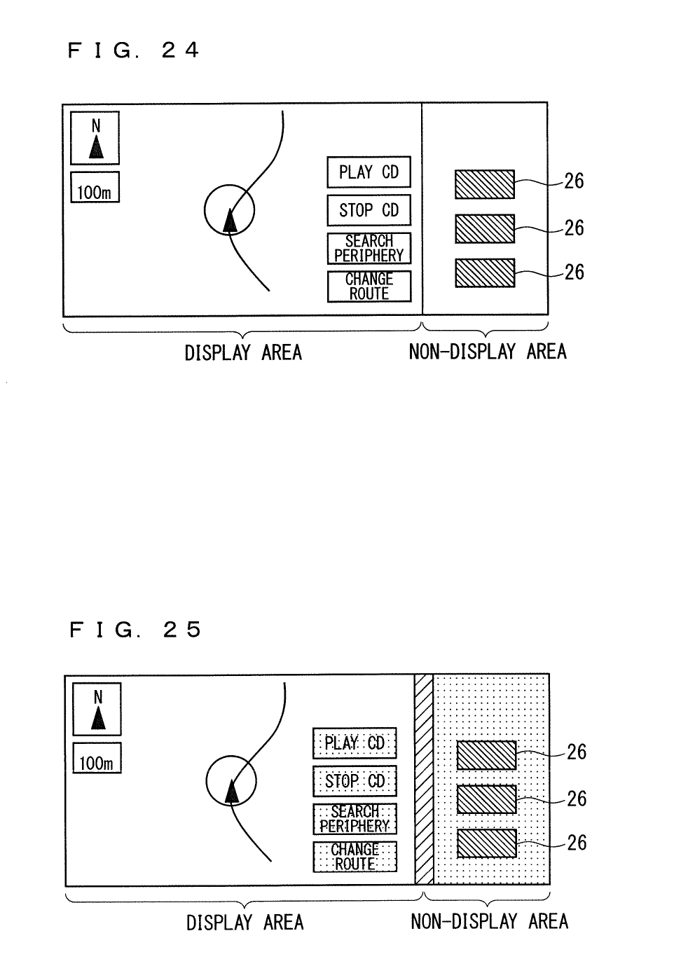

FIG. 24 is a diagram depicting an exemplary behavior of the tactile sensation control apparatus according to the present embodiment 5.

FIG. 24 depicts the display screen of the display 9 corresponding to the display area and the area of the tactile sensation touch panel 10 corresponding to an area including the display area and the non-display area. The display 9 displays a position of the vehicle on a map and icons for various operation (“play CD”, “stop CD”, “search periphery”, and “change route”). On the tactile sensation touch panel 10, areas of the icons in the display area have a “smooth” tactile sensation, areas of operation icons 26 in the non-display area have a “rough” tactile sensation, and a background area other than the operation icons 26 in the non-display area has a “smooth” tactile sensation. Examples of the operation icons 26 include an operation button for an air conditioner function, an operation button for an audio visual (AV) function, and an operation button for a navigation function. Such differentiation in tactile sensation among the respective areas allows a user to easily distinguish positions of the operation icons 26 particularly in the non-display area.

The areas of the operation icons 26 can alternatively have a “moving rough” tactile sensation. Still alternatively, the background area in the non-display area can have a “semi-rough” tactile sensation while the background area (other than the icon areas) in the display area can have a “smooth” tactile sensation. The non-display area can further be provided with a gesture area having a “smooth” tactile sensation.

FIG. 25 is a diagram depicting another exemplary behavior of the tactile sensation control apparatus according to the present embodiment 5.

FIG. 25 depicts the display screen of the display 9 corresponding to the display area and the area of the tactile sensation touch panel 10 corresponding to the area including the display area and the non-display area. The display 9 displays a position of the vehicle on a map and icons for various operation (“play CD”, “stop CD”, “search periphery”, and “change route”). On the tactile sensation touch panel 10, the areas of the icons in the display area have a “semi-rough” tactile sensation, a background area in the display area has a “smooth” tactile sensation, the areas of the operation icons 26 in the non-display area have a “rough” tactile sensation, and the background area other than the operation icons 26 in the non-display area has a “semi-rough” tactile sensation. A boundary area between the display area and the non-display area has a “moving rough” tactile sensation. This allows a user to recognize the respective areas to prevent the user from operating an icon in a wrong area.

As described above, the present embodiment 5 allows a user to easily distinguish the positions of the operation icons 26 in the non-display area. This also allows a user to recognize the respective areas to prevent the user from operating an icon in a wrong area. This enables convenient operation for the user. FIG. 25 exemplifies dividing into the two areas of the display area and the non-display area, each of which can optionally be divided into a plurality of areas. For example, the non-display area can be divided into an area for receiving touch operation and an area for receiving gesture operation, and the background area and the areas of the operation icons can have different tactile sensations respectively in the divided areas.

### Embodiment 6

Initially described will be a configuration of a tactile sensation control apparatus 27 according to the present embodiment 6 of the present invention.

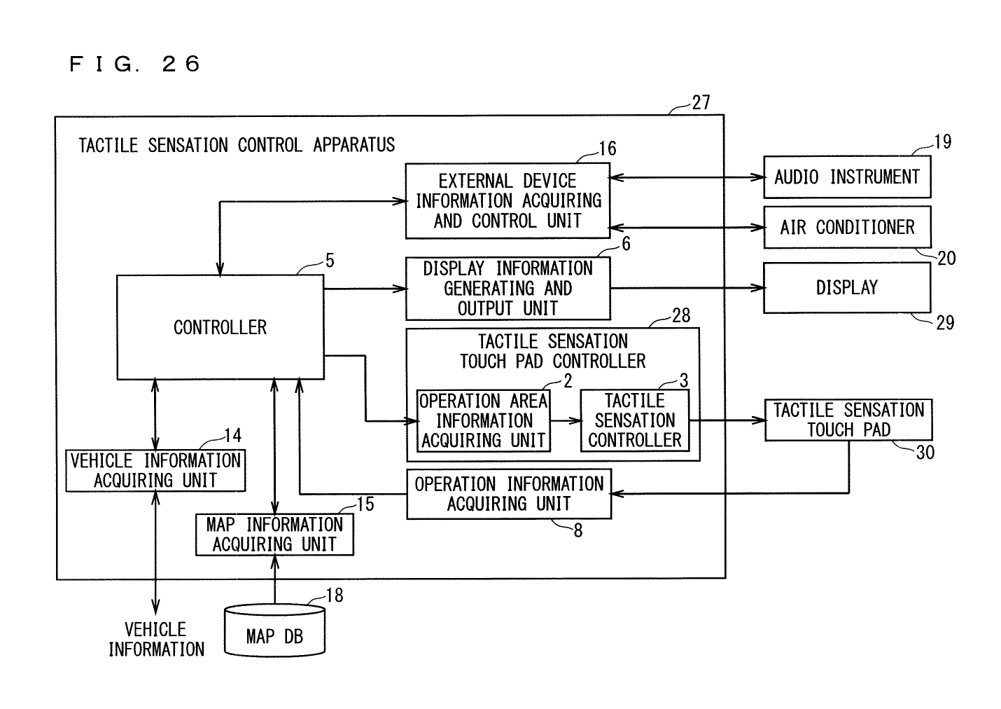

FIG. 26 is a block diagram depicting an exemplary configuration of the tactile sensation control apparatus 27 according to the present embodiment 6.

As depicted in FIG. 26, the tactile sensation control apparatus 27 includes a tactile sensation touch pad controller 28. The display information generating and output unit 6 is connected to a display 29, and the tactile sensation touch pad controller 28 and the operation information acquiring unit 8 are connected to a tactile sensation touch pad 30. The other configurations are similar to those of the tactile sensation control apparatus 13 according to the embodiment 2 (see FIG. 12) (except for the communication unit 17 in FIG. 12) and will not herein be described repeatedly.

The tactile sensation touch pad controller 28 has functions similar to those of the tactile sensation touch panel controller 7 depicted in FIG. 12. Specifically, the tactile sensation touch pad controller 28 transmits tactile sensation control information to the tactile sensation touch pad 30 in accordance with a command from the controller 5.

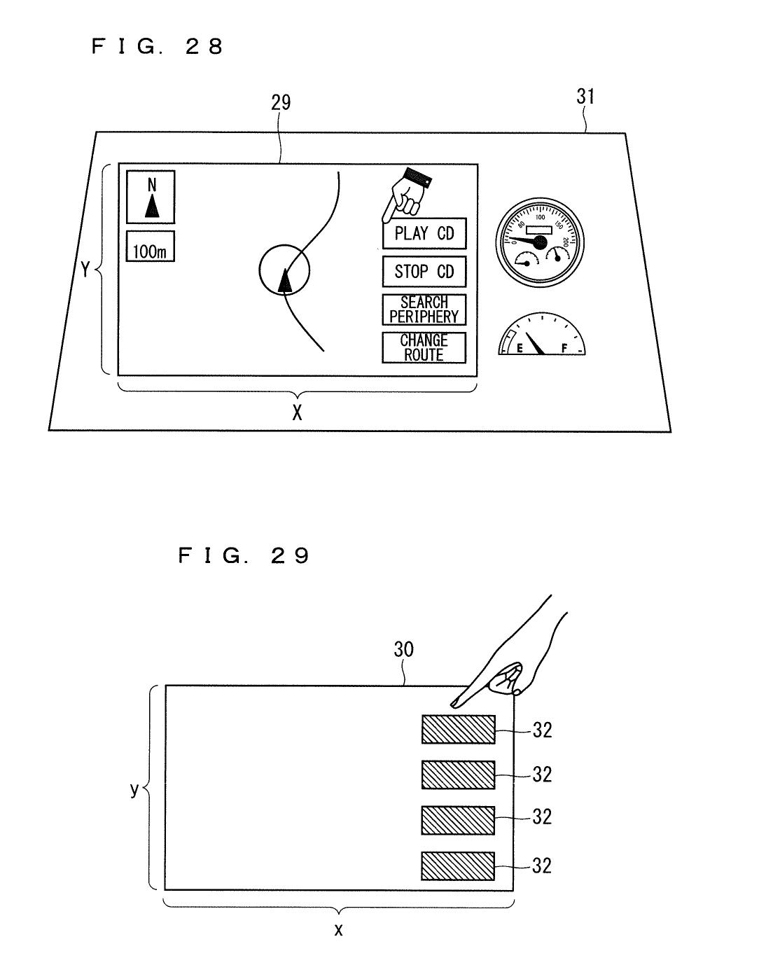

The display 29 is provided at a meter panel (see a meter panel 31 in FIG. 28, for example) of a vehicle instrument panel unit.

The tactile sensation touch pad 30 is provided separately at a different site from the display 29.

Behaviors of the tactile sensation control apparatus 27 will be described next.

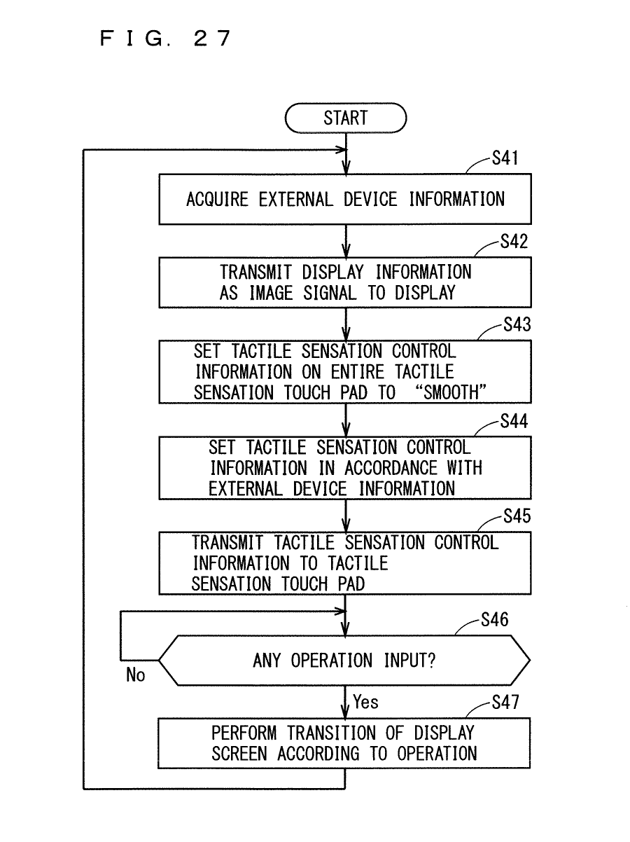

FIG. 27 is a flowchart of exemplary behaviors of the tactile sensation control apparatus 27.

In step S41, the external device information acquiring and control unit 16 acquires external device information from the external devices (the audio instrument 19 or the air conditioner 20). The acquired external device information is transmitted to the controller 5.

In step S42, the display information generating and output unit 6 generates display information in accordance with a command from the controller 5, converts the generated display information to an image signal, and transmits the image signal to the display 9. The display information includes the external device information in this case.

In step S43, the tactile sensation touch pad controller 28 sets tactile sensation control information on the entire tactile sensation touch pad 30 to “smooth” in accordance with the command from the controller 5.

In step S44, the tactile sensation touch pad controller 28 sets tactile sensation control information in accordance with the command from the controller 5, so as to generate a tactile sensation at a position on the tactile sensation touch pad 30 corresponding to an area of an icon for operation of an external device.

In step S45, the tactile sensation touch pad controller 28 transmits, to the tactile sensation touch pad 30, the tactile sensation control information set in steps S43 and S44. The tactile sensation touch pad 30 comes into a state of having areas differentiated in tactile sensation in accordance with the tactile sensation control information transmitted from the tactile sensation touch pad controller 28.

In step S46, the controller 5 determines whether or not a user operates the tactile sensation touch pad 30 via the operation information acquiring unit 8. The controller 5 stands by until a user operates the tactile sensation touch pad 30, and the process proceeds to step S47 if the user operates the tactile sensation touch pad 30.

In step S47, the controller 5 performs transition of the display screen according to user operation.

Exemplary specific behaviors of the tactile sensation control apparatus 27 will be described next with reference to FIGS. 28 and 29.

FIG. 28 depicts exemplary display on the display 29 provided at the meter panel 31. As depicted in FIG. 28, the meter panel 31 is provided with the display 29 and various gauges. The display 29 displays a position of the vehicle on a map and icons for various operation (“play CD”, “stop CD”, “search periphery”, and “change route”). The display 29 can alternatively have a display area occupying the entire meter panel 31.

FIG. 29 exemplifies tactile sensations of the respective areas on the tactile sensation touch pad 30. Areas of operation icons 32 have a “rough” tactile sensation while the area other than the operation icons 32 has a “smooth” tactile sensation.

An area having a vertical side y and a horizontal side x on the tactile sensation touch pad 30 corresponds to an area having a vertical side Y and a horizontal side X on the display 29. The area having the vertical side y and the horizontal side x on the tactile sensation touch pad 30 and the area having the vertical side Y and the horizontal side X on the display 29 can be sized equally, similarly, or not similarly to each other. The operation icons 32 on the tactile sensation touch pad 30 correspond to the icons on the display 29. As exemplified in FIGS. 28 and 29, the “play CD” icon on the display 29 is selected when a user touches the uppermost operation icon 32 on the tactile sensation touch pad 30. In this case, the display 29 can be configured to display a prompt (a hand sign) at a position corresponding to the touched position on the tactile sensation touch pad 30.

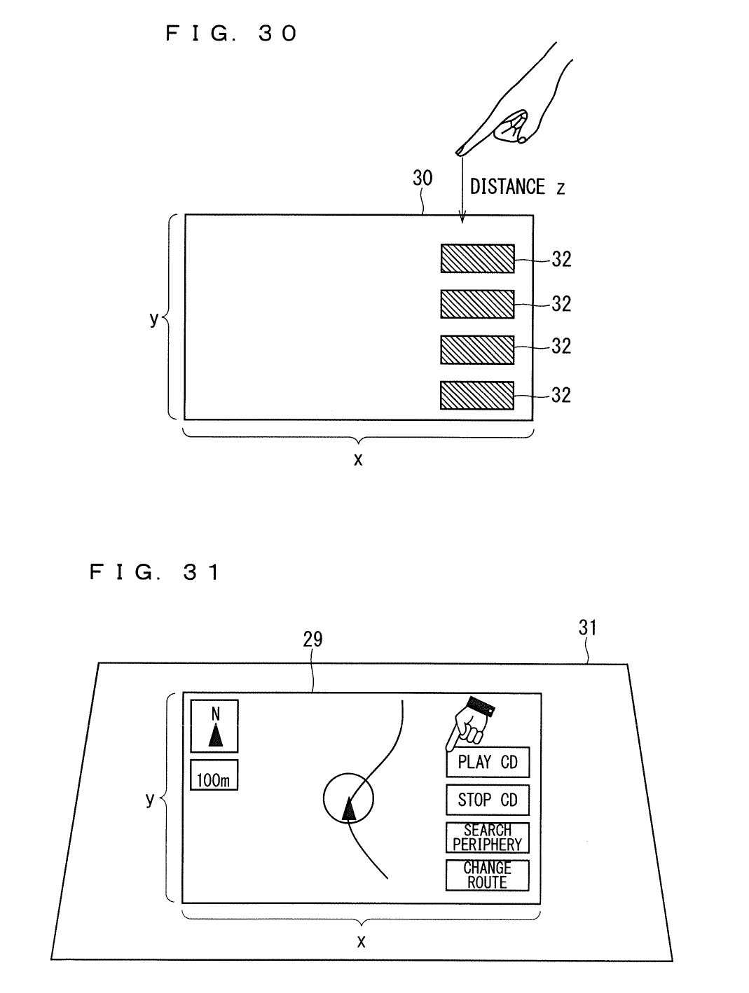

The tactile sensation touch pad 30 described above has the function of detecting user's touch onto the tactile sensation touch pad 30. The present invention is not limited to this configuration. For example, the tactile sensation touch pad 30 can alternatively have a function of detecting a three-dimensional position of an indicator (e.g. a user's finger), or a function of detecting a three-dimensional position of an electrostatic touch pad indicator (an indicator onto the touch pad). A three-dimensional position of an indicator can be detected by adoption of an electrostatic touch panel, recognition of a position of the indicator through image processing, or the like. FIGS. 30 and 31 are diagrams depicting an exemplary specific behavior of the tactile sensation control apparatus 27 in a case where the tactile sensation touch pad 30 has the function of recognizing a three-dimensional position of an indicator. Tactile sensations of the respective areas on the tactile sensation touch pad 30 in FIG. 30 and display on the display 29 in FIG. 31 are similar to those in FIG. 28 and FIG. 29, and will not herein be described repeatedly.

The display 29 may not display the prompt (hand sign) at a corresponding position if the tactile sensation touch pad 30 does not have the function of detecting a three-dimensional position thereon. Alternatively, the prompt (hand sign) can be displayed when a user lightly touches the tactile sensation touch pad 30, and an operation icon can be regarded as being operated when the user presses the tactile sensation touch pad 30.

When a user brings a finger close to the tactile sensation touch pad 30 and the user's finger is positioned within a predetermined distance (a distance z in the height direction) from the tactile sensation touch pad 30 as depicted in FIG. 30, the prompt is displayed, on the display screen of the display 29, at a corresponding position on XY coordinates of the finger detected by the tactile sensation touch pad 30 as depicted in FIG. 31.

As described above, the present embodiment 6 allows a user to operate icons on the display 29 without viewing the tactile sensation touch pad 30. This enables convenient operation for the user.

The tactile sensation control apparatus described above is applicable to an on-vehicle navigation system or a car navigation system, as well as a vehicle-mountable portable navigation device (PND), a mobile communication terminal (e.g. a mobile phone, a smartphone, or a tablet terminator), a navigation device built up as a system in appropriate combination with a server or the like, and a device other than the navigation device. In this case, the functions or the constituent elements of the tactile sensation control apparatus are distributed to functions configuring the system.

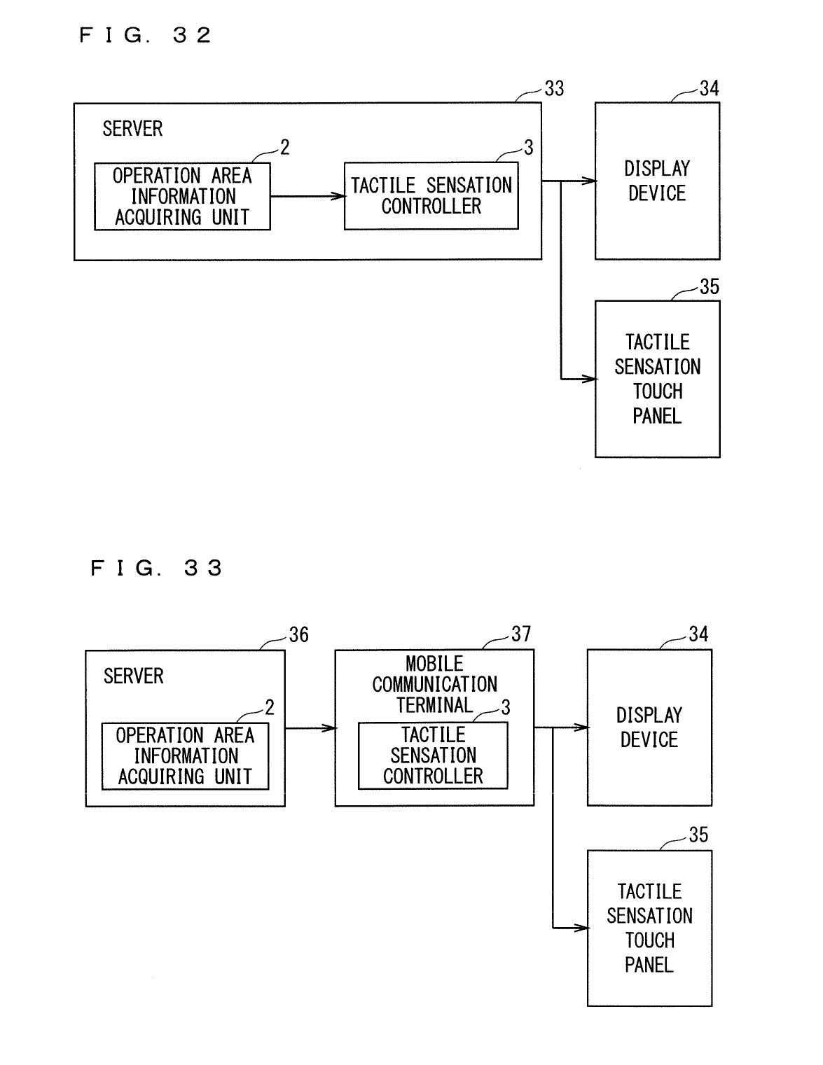

Specifically, according to an example, the functions of the tactile sensation control apparatus can be provided at a server. As exemplified in FIG. 32, a tactile sensation control system is built up with including a display device 34 and a tactile sensation touch panel 35 (or a tactile sensation touch pad) at a user's end as well as a server 33 provided with at least the operation area information acquiring unit 2 and the tactile sensation controller 3. The operation area information acquiring unit 2 and the tactile sensation controller 3 function similarly to the operation area information acquiring unit 2 and the tactile sensation controller 3 depicted in FIG. 1, respectively. The server 33 can alternatively include the constituent elements depicted in FIGS. 7, 12, and 26 as necessary. In this case, the constituent elements included in the server 33 can appropriately be distributed to the server 33 and the display device 34.

According to another example, the functions of the tactile sensation control apparatus can be provided at the server and a mobile communication terminal. As exemplified in FIG. 33, a tactile sensation control system is built up with including the display device 34 and the tactile sensation touch panel 35 (or a tactile sensation touch pad) at the user's end, a server 36 provided with at least the operation area information acquiring unit 2, and a mobile communication terminal 37 provided with at least the tactile sensation controller 3. The operation area information acquiring unit 2 and the tactile sensation controller 3 function similarly to the operation area information acquiring unit 2 and the tactile sensation controller 3 depicted in FIG. 1, respectively. The server 36 and the mobile communication terminal 37 can alternatively include the constituent elements depicted in FIGS. 7, 12, and 26 as necessary. In this case, the constituent elements included in the server 36 and the mobile communication terminal 37 can appropriately be distributed to the display device 34, the server 36, and the mobile communication terminal 37.

The above configuration also achieves effects similar to those of the above embodiments.

Software (a tactile sensation control method) configured to execute the behaviors mentioned in the above embodiments can be incorporated in a server, a mobile communication terminal, or the like.

Specifically, the tactile sensation control method is exemplary for controlling a tactile sensation of a user operating an operation surface of a touch panel or a touch pad, the method including: acquiring operation area information on an operation area for operation by the user on the operation surface and on an operation type corresponding to the operation area; and controlling the tactile sensation on the operation surface to cause the operation area of the acquired operation area information to have a tactile sensation according to the operation type corresponding to the operation area.

As described above, the software configured to execute the behaviors mentioned in the above embodiments can be incorporated in a server or a mobile communication terminal to achieve effects similar to those of the above embodiments.

The operation area information acquiring unit 2, the tactile sensation controller 3, the controller 5, the display information generating and output unit 6, the tactile sensation touch panel controller 7, the operation information acquiring unit 8, the vehicle information acquiring unit 14, the map information acquiring unit 15, the external device information acquiring and control unit 16, the communication unit 17, and the tactile sensation touch pad controller 28 depicted in FIGS. 1, 7, 12, 26, 32, and 33 are each embodied by processing a program using a central processing unit (CPU) according to the software. Where possible, the operation area information acquiring unit 2, the tactile sensation controller 3, the controller 5, the display information generating and output unit 6, the tactile sensation touch panel controller 7, the operation information acquiring unit 8, the vehicle information acquiring unit 14, the map information acquiring unit 15, the external device information acquiring and control unit 16, the communication unit 17, and the tactile sensation touch pad controller 28 are each configured as hardware (e.g. an arithmetic/processing circuit configured to perform specific calculation or processing to an electric signal). The both configurations described above can alternatively be provided together.

The present invention also includes free combination of the embodiments as well as appropriate modification of and removal from the embodiments within the scope of the invention.

The above detailed description of the present invention should be exemplary in every aspect and should not limit the scope of the invention. Infinite modification examples not described herein should not to be excluded from the scope of the invention.

### REFERENCE SIGNS LIST

1: tactile sensation control apparatus

2: operation area information acquiring unit

3: tactile sensation controller

4: tactile sensation control apparatus

5: controller

6: display information generating and output unit

7: tactile sensation touch panel controller

8: operation information acquiring unit

9: display

10: tactile sensation touch panel

11: operation icon

12: gesture area

13: tactile sensation control apparatus

14: vehicle information acquiring unit

15: map information acquiring unit

16: external device information acquiring and control unit

17: communication unit

18: map DB

19: audio instrument

20: air conditioner

21: navigation operation icon

22: air conditioner operation icon

23: hands-free operation icon

24: map scale switching icon

25: display switching icon

26: operation button

27: tactile sensation control apparatus

28: tactile sensation touch pad controller

29: display

30: tactile sensation touch pad

31: meter panel

32: operation icon

33: server

34: display device

35: tactile sensation touch panel

36: server

37: mobile communication terminal

1.-15. (canceled)

16. A tactile sensation control system configured to control a tactile sensation of a user operating an operation surface of a touch panel or a touch pad, the system comprising:
a processor to execute a program; and
a memory to store the program which, when executed by the processor, performs processes of:
acquiring operation area information on at least one operation area for operation by said user on said operation surface and on an operation type corresponding to said operation area; and
controlling said tactile sensation on said operation surface so that said operation area in said acquired operation area information causes said user to have a tactile sensation according to said operation type corresponding to said operation area, wherein
said operation area includes a gesture operation area receiving a gesture operation by said user, and an icon operation area receiving an icon operation by said user.

17. The tactile sensation control system according to claim 16, wherein when said user operates one of said gesture operation area and said icon operation area, said tactile sensation on said operation surface is controlled in said controlling so that a tactile sensation on said one of said gesture operation area and said icon operation area changes with a lapse of time.

18. The tactile sensation control system according to claim 17, wherein
said controlling includes controlling said tactile sensation on said operation surface so that a position of said tactile sensation on said one of said gesture operation area and said icon operation area changes with a lapse of time.

19. The tactile sensation control system according to claim 18, wherein
said controlling includes controlling said tactile sensation on said operation surface so that said position of said tactile sensation on said one of said gesture operation area and said icon operation discretely changes.

20. The tactile sensation control system according to claim 17, wherein
said controlling includes controlling said tactile sensation on said operation surface so that a pattern of said tactile sensation on said one of said gesture operation area and said icon operation area changes with a lapse of time.

21. The tactile sensation control system according to claim 16, wherein
when said operation type corresponds to said gesture operation by said user, said tactile sensation is controlled in said controlling so that said gesture operation area receiving said gesture operation causes said user to have a predetermined tactile sensation.

22. The tactile sensation control system according to claim 16, wherein
when said operation type corresponds to said icon operation by said user,
said tactile sensation is controlled in said controlling so that said user has a predetermined tactile sensation corresponding to said icon operation.

23. The tactile sensation control system according to claim 16, wherein
said controlling includes controlling said tactile sensation so that said tactile sensation of said operation area on said operation surface differs from a tactile sensation of a non-operation area other than said operation area on said operation surface.

24. The tactile sensation control system according to claim 16, wherein
said controlling includes controlling said tactile sensation so that said operation area protrudes from said operation surface in accordance with said operation type corresponding to said operation area in said operation area information.

25. The tactile sensation control system according to claim 16, wherein
said operation surface has a plurality of areas including said at least one operation area, and
said controlling includes controlling said tactile sensation so that an area corresponding to a boundary between said areas causes said user to have a predetermined tactile sensation.

26. The tactile sensation control system according to claim 16, wherein
said operation surface has a plurality of areas including said at least one operation area, and
said controlling includes controlling said tactile sensation for each of said areas.

27. The tactile sensation control system according to claim 16, wherein
said operation surface includes a plurality of operation areas including said at least one operation area, and
said controlling includes controlling said tactile sensation so that said tactile sensation differs regularly for each of said operation areas.

28. The tactile sensation control system according to claim 16, wherein
said operation surface includes a plurality of operation areas including said at least one operation area, and
said controlling includes controlling said tactile sensation so that said tactile sensation of said operation area that is predetermined differs from a tactile sensation of a remaining operation area of said operation area.

29. The tactile sensation control system according to claim 16, wherein
said processor acquires, as operation target device information, information on at least one device to be operated by said user or on at least one function of said device, and
said controlling includes controlling said tactile sensation so that said tactile sensation corresponds to said device or said function in accordance with said acquired operation target device information.

30. The tactile sensation control system according to claim 29, wherein said controlling includes controlling said tactile sensation so that said tactile sensation differs for each of operation areas corresponding to different devices.

31. The tactile sensation control system according to claim 29, wherein said controlling includes controlling said tactile sensation so that said user has an identical tactile sensation for operation areas corresponding to similar functions in said device.

32. The tactile sensation control system according to claim 29, wherein said controlling includes controlling said tactile sensation so that an area corresponding to said device or said function protrudes from said operation surface.

33. A tactile sensation control method of controlling a tactile sensation of a user operating an operation surface of a touch panel or a touch pad, the method comprising:
acquiring operation area information on an operation area for operation by said user on said operation surface and on an operation type corresponding to said operation area; and
controlling said tactile sensation on said operation surface so that said operation area in said acquired operation area information causes said user to have a tactile sensation according to said operation type corresponding to said operation area, wherein
said operation area includes a gesture operation area receiving a gesture operation by said user, and an icon operation area receiving an icon operation by said user.

34. The tactile sensation control method according to claim 33, wherein
when said user operates one of said gesture operation area and said icon operation area, said tactile sensation on said operation surface is controlled in said controlling so that a tactile sensation on said one of said gesture operation area and said icon operation area changes with a lapse of time.

35. The tactile sensation control method according to claim 34, wherein
said controlling includes controlling said tactile sensation on said operation surface so that a position of said tactile sensation on said one of said gesture operation area and said icon operation area changes with a lapse of time.
